(19) United States
(12) Patent Application Publication
(10) Pub. No.: US 2005/0272831 A1
(43) Pub. Date: Dec. 8, 2005

(54) Aqueous inkjet ink compositon

(75) Inventors: Xiaoru Wang, Webster, NY (US); Gang C. Han-Adebekun, Pittsford, NY (US); Mary C. Brick, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/860,989

(22) Filed: Jun. 4, 2004

(51) Int. Cl. C03C 17/00; C09D 11/00

(52) U.S. Cl. 523/160; 523/161

(57) ABSTRACT

This invention relates to an ink jet ink composition comprising water, a humectant, a non-encapsulated pigment and a water soluble polymer, wherein the polymer comprises a vinyl acetate monomer and has a number average molecular weight less than 200,000.

### FIELD OF THE INVENTION

This invention relates to an aqueous ink jet ink which comprises an aqueous carrier medium, a pigment and a vinyl acetate containing polymer which can be either a dispersant or a binder. The inks have good jetting performance, improved image quality such as inter-color bleed and image stability including both ozone resistance and weatherability.

### BACKGROUND OF THE INVENTION

Ink jet printing is a non-impact method for producing images by the deposition of ink droplets on a substrate (paper, transparent film, fabric, etc.) in response to digital signals. Ink jet printers have found broad applications across markets ranging from industrial labeling to short run printing to desktop document and pictorial imaging and large format printing for outdoor applications such as banners, signage, displays, posters, billboard and bus wraps.

In ink jet recording processes, it is necessary that the inks being used meet various performance requirements. Such performance requirements are generally more stringent than those for other liquid ink applications, such as for writing instruments (e.g., a fountain pen, felt pen, etc.). In particular, the following conditions are generally required for inks utilized in ink jet printing processes:
(1) The ink should possess physical properties such as viscosity, surface tension, and electric conductivity matching the discharging conditions of the printing apparatus, such as the driving voltage and driving frequency of a piezoelectric electric oscillator, the form and material of printhead orifices, the diameter of orifices, etc;
(2) The ink should be capable of being stored for a long period of time without causing clogging of printhead orifices during use;
(3) The ink should be quickly fixable onto recording media, such as paper, film, etc., such that the outlines of the resulting ink dots are smooth and there is minimal blotting of the dotted ink;
(4) The printed image should be of high quality, such as having a clear color tone and high density, have high gloss and high color gamut and minimal image artifacts, e.g. inter-color bleed
(5) The printed image should exhibit good image stabilities particularly for applications where images are used for outdoor displays. Some of the environmental conditions include ozone, lights as well as rains.

The inks used in various ink jet printers can be classified as either dye-based or pigment-based. A dye is a colorant which is molecularly dispersed or solvated by a carrier medium. The carrier medium can be a liquid or a solid at room temperature. A commonly used carrier medium is water or a mixture of water and organic co-solvents. Each individual dye molecule is surrounded by molecules of the carrier medium. In dye-based inks, no particles are observable under the microscope. Although there have been many recent advances in the art of dye-based ink jet inks, such inks still suffer from deficiencies such as poor lightfastness. When water is used as the carrier medium, such inks also generally suffer from poor waterfastness.

Pigment-based inks have been gaining in popularity as a means of addressing these limitations. In pigment-based inks, the colorant exists as discrete particles. These pigment particles are usually treated with addenda known as dispersants or stabilizers which serve to keep the pigment particles from agglomerating and/or settling out.

Pigment-based inks suffer from a different set of deficiencies than dye-based inks. One deficiency is that pigment-based inks interact differently with specially coated papers and films. In particular, it has been observed that pigment-based inks produce imaged areas that are entirely on the surface of coated papers and films which results in images that have high tendency to generate image artifacts, such as coalescence and inter-color bleed. In addition, since pigments inks are well-known for its usage for outdoor display applications, the image stability requirements are in general based on fairly harsh environmental conditions, such as high ozone level exposure, direct UV containing sun lights as well as rains and dust exposure. Under these outdoor conditions, even pigment based inks can be very sensitive and fade significantly when the air permeability is high, such as when they are printed onto porous, glossy receivers as well as coated porous vinyl receivers.

U.S. Pat. No. 6,323,257B1 describes an ink containing reactive macromolecular chromophores, for which one of the monomers can be vinyl acetate. However, using a reactive mechanism to make macromolecular chromophores is very expensive and complicated. There is a need to incorporate the polymer into the ink by a simpler and less expensive process such as polymeric dispersant or polymeric binder approach, yet achieve the same performance.

U.S. Pat. No. 6,232,369 B1 describes a pigment ink with a hydrosol polymer containing at least one non-ionic hydrophilic ethylene oxide for smear resistance, for which one of the monomer can be vinyl acetate. But the polymer is mainly water insoluble in ink media, which might cause plugged printer heads. There is a need to develop a polymer which will give the same ink performance while still maintaining reliability in a printer head.

U.S. Application U.S. 20030106462A1 describes a pigment enveloped in a polymer in which the polymer can be a vinyl acecate polymer. This approach needs an extra step to envelop the pigment making it more time-consuming and more expensive.

EP 0937759 A1 describes pigment or dye based inks containing a polymer of very high molecular weight, between 200,000 and 40 million g/mol. e.g. containing partially hydrolyzed poly(vinyl acetate). A polymer of this type would have jetting problems if utilized in ink jet printing, particularly if used with a thermal printhead.

Therefore, there is clearly a need to provide a pigmented ink composition which can be made with an easy and low cost approach and can be jetted with a common ink jet printhead. There is further a need for an ink which, when used in printing images on the surface of an ink jet receiving element, demonstrates improved ozone stability and weatherability while having minimal image quality artifacts.

### SUMMARY OF THE INVENTION

This invention provides an ink jet ink composition comprising water, a humectant, a non-encapsulated pigment and a water soluble polymer, wherein the polymer comprises a vinyl acetate monomer and has a number average molecular weight less than 200,000. It further comprises an ink jet printing method comprising the steps of:
A) providing an ink jet printer that is responsive to digital data signals;
B) loading said printer with an ink jet recording element
C) loading said printer with an ink jet ink composition comprising water, a humectant, a non-encapsulated pigment and a water soluble polymer, wherein the polymer comprises vinyl acetate and has a number average molecular weight less than 200,000; and
D) printing on said ink jet recording element using said ink jet ink composition in response to said digital data signals.

The ink jet ink composition is easy and economical to manufacture. It can be jetted with most commercial ink jet print heads and it has improved ozone stability and weatherability. It also has few image artifacts.

### DETAILED DESCRIPTION OF THE INVENTION

The polymer used in this invention is a polymer with both hydrophobic and hydrophilic monomers. The polymer comprises a vinyl acetate monomer as one type of hydrophobic monomer. Vinyl acetate has a Tg of 0° C. and it also provides very good adhesion to many substrates. This provides many improved properties including image stability and image quality.

The hydrophilic monomers used in the polymer include, but are not limited to, acrylic acid, methacrylic acid, acrylimide, ethacrylic acid, acrylamide, methacrylamide, N,N-dimethyl acrylamide, N-methyl acrylamide, N-methyl methacrylamide, aryloxy dimethyl acrylamide, N-methyl acrylamide, N-methyl methacrylamide, aryloxy piperidine, and N,N-dimethyl acrylamide acrylic acid, methacrylic acid, chloromethacrylic acid, maleic acid, allylamine, N,N-diethylallylamine, vinyl sulfonamide, sodium acrylate, sodium methacrylate, ammonium acrylate, ammonium methacrylate, acrylamidopropanetriethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium styrenesulfonate, sodium acrylamidopropanesulfonate, sodium methacrylamidopropanesulfonate, and sodium vinyl morpholine sulfonate, allyl methacrylate, allyl acrylate, butenyl acrylate, undecenyl acrylate, undecenyl methacrylate, vinyl acrylate, and vinyl methacrylate; dienes such as butadiene and isoprene; esters of saturated glycols or diols with unsaturated monocarboxylic acids such as, ethylene glycol diacrylate, ethylene glycol dimethacrylate, triethylene glycol dimethacrylate, 1,4-butanediol dimethacrylate, 1,3-butanediol dimethacrylate, pentaerythritol tetraacrylate, trimethylol propane trimethacrylate. Preferred the hydrophilic monomers comprise carboxylic acid. The polymer may comprise just one of the above hydrophilic monomer types or it can comprise various combinations of the monomers.

The polymer used in this invention may comprise hydrophobic monomers in addition to the vinyl acetate monomer. These hydrophobic monomers can be any vinyl-type monomers including, for example, allyl compounds, vinyl ethers, vinyl heterocyclic compounds, styrenes, olefins and halogenated olefins, ethylenically unsaturated carboxylic acids and esters derived from them, unsaturated nitriles, vinyl alcohols, acrylamides and methacrylamides, vinyl ketones, or multifunctional monomers. The polymer may comprise just one of the above hydrophobic monomer types or it can comprise various combinations of the monomers.

The preferred additional hydrophobic monomers are styrene/acrylic monomers. They can be methyl acrylate, ethyl acrylate, ethyl methacrylate, benzyl acrylate, benzyl methacrylate, propyl acrylate, propyl methacrylate, iso-propyl acrylate, iso-propyl methacrylate, butyl acrylate, butyl methacrylate, hexyl acrylate, hexyl methacrylate, octadecyl methacrylate, octadecyl acrylate, lauryl methacrylate, lauryl acrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, phenethylacrylate, phenethyl methacrylate, 6-phenylhexyl acrylate, 6-phenylhexyl methacrylate, phenyllauryl acrylate, phenyllaurylmethacrylate, 3-nitrophenyl-6-hexyl methacrylate, 3-nitrophenyl-18-octadecyl acrylate, ethyleneglycol dicyclopentyl ether acrylate, vinyl ethyl ketone, vinyl propyl ketone, vinyl hexyl ketone, vinyl octyl ketone, vinyl butyl ketone, cyclohexyl acrylate, 3-methacryloxypropyl-dimethylmethoxysilane, 3-methacryloxypropyl-methyldimethoxysilane, 3-methacryloxypropyl-pentamethyldisiloxane, 3-methacryloxypropyltris-(trimethylsiloxy)silane, 3-acryloxypropyl-dimethylmethoxysilane, acryloxypropylmethyldimethoxysilane, trifluoromethyl styrene, trifluoromethyl acrylate, trifluoromethyl methacrylate, tetrafluoropropyl acrylate, tetrafluoropropyl methacrylate, heptafluorobutyl methacrylate, isobutyl acrylate, isobutyl methacrylate, 2-ethylhexyl acrylate, 2-ethylhexyl methacrylate, isooctyl acrylate, isooctyl methacrylate, N,N-dihexyl acrylamide, N,N-dioctyl acrylamide, N,N-dimethylaminoethyl acrylate, N,N-dimethylaminoethyl methacrylate, N,N-diethylaminoethyl acrylate, N,N-diethylaminoethyl methacrylate, piperidino-N-ethyl acrylate, vinyl propionate, vinyl acetate, vinyl butyrate, vinyl butyl ether, and vinyl propyl ether ethylene, styrene, vinyl carbazole, vinyl naphthalene, vinyl anthracene, vinyl pyrene, methyl methacrylate, methyl acrylate, alpha-methylstyrene, dimethylstyrene, methylstyrene, vinylbiphenyl, glycidyl acrylate, glycidyl methacrylate, glycidyl propylene, 2-methyl-2-vinyl oxirane, vinyl pyridine, aminoethyl methacrylate, aminoethylphenyl acrylate, maleimide, N-phenyl maleimide, N-hexyl maleimide, N-vinyl-phthalimide, and N-vinyl maleimide poly(ethylene glycol) methyl ether acrylate, polyvinyl alcohol, vinyl pyrrolidone, vinyl 4-methylpyrrolidone, vinyl 4-phenylpyrrolidone, vinyl imidazole, vinyl 4-methylimidazole, vinyl 4-phenylimidazole, methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, benzyl methacrylate, 2-hydroxypropyl methacrylate, acrylonitrile, methacrylonitrile, vinyl acetate, vinyl propionate, vinylidene chloride, vinyl chloride, styrene, t-butyl styrene, vinyl toluene, butadiene, isoprene, N,N-dimethyl acrylamide, acrylic acid, methacrylic acid, chloromethacrylic acid, maleic acid, allylamine, N,N-diethylallylamine, vinyl sulfonamide, sodium acrylate, sodium methacrylate, ammonium acrylate, ammonium methacrylate, acrylamidopropane-triethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium 2-acrylamido-2-methyl-1-propanesulfonate or sodium styrenesulfonate. The more preferred additional hydrophobic monomers are acrylate and methacrylate and their derivatives.

Addition polymerization initiators useful in the practice of the invention include, for example, azo and diazo compounds, such as 2,2′-azobisisobutyronitrile, 2,2′-azobis(2,4-dimethyl valeronitrile), 2,2′-azobis(2,3-dimethyl butyronitrile), 2,2′-azobis(2-methyl butyronitrile), 2,2′-azobis(2,3,3-trimethyl butyronitrile), 2,2′-azobis(2-isopropyl butyronitrile), 1,1′-azobis(cyclohexane-1-carbonitrile), 2,2′-azobis(4-methoxyl-2,4-dimethyl valeronitrile), 2-(carbamoylazo)isobutyronitrile, 4,4′-azobis(4-cyanovaleric acid), and dimethyl-2,2′azobis isobutyrate, or peroxide compounds, such as butyl peroxide, propyl peroxide, butyryl peroxide, benzoyl isobutyryl peroxide, and benzoyl peroxide, or water soluble initiators, for example, sodium persulfate, and potassium persulfate, or any redox initiators. Preferred initiators are the oil soluble initiators. Examples of particularly suitable initiators are azo, peroxide, persulfate, and redox initiators. The initiators may be used in an amount varying from about 0.2 to 4 weight percent or higher by weight of the total monomers. A chain transfer agent such as butyl mercaptan, may also be used to control the properties of the polymer formed.

Depending on the types of initiators used, the reaction temperature can vary from about 30° C. to about 200° C. Preferably the reaction temperature is at least 40° C., and most preferably at least 50° C. To ensure that no free monomer is present, usually the reaction is continued for a time after the monomer addition. Also, more initiator may need to be added as a scavenger during the final stage of the reaction to increase the reaction conversion.

The polymers can be made via solution, or bulk polymerization and then post-emulsification. The polymers employed in the invention in general have a Tg of −50 to 150° C., preferably 5 to 100° C. The number average molecular weight of the polymer is less than 200,000. The preferred number average molecular weight is less than 150,000. The more preferred number average molecular weight is less than 100,000 and the even more preferred number average molecular weight is less than 50,000. In one suitable embodiment the number average molecular weight is less than 20,000.

The polymer in this invention is a water soluble polymer; which is defined as polymer having water solubility of 0.5 weight % or higher at 25° C. The polymer in this invention can be incorporated into the ink composition as an additive, or a binder. The polymer can also be incorporated as a dispersant to stabilize the pigment particles. In both cases, the pigment is not encapsulated by the polymer as disclosed in U.S. Application U.S. 20030106462A1.

The polymer used in this invention contains vinyl acetate in the range of 1 to 90 weight % of the polymer. Preferably, the polymer in this invention contains vinyl acetate in the range of 5 to 50 weight % of the polymer, and more preferably in the range of 10 to 30 weight % of the polymer.

The polymer used in this invention can be incorporated into the ink composition at less than 10 weight % of the ink. Preferably, the polymer in this invention is incorporated into the ink composition from about 0.5% to about 5% by weight of the ink.

The ink composition of the invention may be colored with any type of organic or inorganic pigment, either alone or in combination, in order to give the desired color. To this end, the exact choice of pigments will depend upon the specific application and performance requirements such as color reproduction and image stability. Examples of useful pigments include those described in, for example, U.S. Pat. Nos. 5,026,427; 5,086,698; 5,141,556; 5,160,370; and 5,169,436. Typical ink compositions are cyan, magenta, yellow, black, red, violet, green, blue, orange, etc.

In general, useful pigments may be azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

In a preferred embodiment of the invention, the pigment is C.I. Pigment Yellow 74, 128, 155; C.I. Pigment Red 122, 177, 202; C.I. Pigment Blue 15:3, the siloxane-bridged aluminum phthalocyanine, bis(phthalocyanylalumino) tetraphenyldisiloxane, represented by the following formula:
PcAl—O—[SiR₂—O]₂—AlPc
where R is a phenyl group and Pc is unsubstituted; C.I. Pigment Violet 23; or carbon black. The aforementioned pigments are preferred because they provide better color gamut as compared to those that are not preferred. In another preferred embodiment, cyan pigments are used because ink compositions containing these pigments are especially difficult to jet.

Pigments for use in the ink compositions of the invention may be prepared by any method known in the art of ink jet printing. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium which is typically the same as or similar to the medium used to dilute the pigment dispersion in step (b). Inert milling media are optionally present in the milling step (a) in order to facilitate break up of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

A dispersant is optionally present in the milling step (a) in order to facilitate break up of the pigments into primary particles. For the pigment dispersion obtained in step (a) or the ink composition obtained in step (b), a dispersant is optionally present in order to maintain particle stability and prevent settling. Dispersants suitable for use in the invention include, but are not limited to, those commonly used in the art of ink jet printing. For aqueous pigment-based ink compositions, useful dispersants include anionic, cationic or nonionic surfactants such as sodium dodecylsulfate, or potassium or sodium oleoylmethyltaurate as described in, for example, U.S. Pat. No. 5,679,138; U.S. Pat. No. 5,651,813 or U.S. Pat. No. 5,985,017.

Polymeric dispersants are also useful in aqueous pigment-based ink compositions of the invention. Polymeric dispersants may be added to the pigment dispersion prior to or during the milling step (a) and include polymers such as homopolymers and copolymers; anionic, cationic or nonionic polymers; or random, block, branched or graft polymers. Polymeric dispersants particularly useful in the invention include random and block copolymers having hydrophilic and hydrophobic portions; see for example, U.S. Pat. No. 4,597,794; U.S. Pat. No. 5,085,698; U.S. Pat. No. 5,519,085; U.S. Pat. Nos. 5,272,201; 5,172,133; or U.S. Pat. No. 6,043,297; and graft copolymers; see for example, U.S. Pat. No. 5,231,131; U.S. Pat. No. 6,087,416; U.S. Pat. No. 5,719,204; or U.S. Pat. No. 5,714,538.

Ink compositions of the invention may also contain self-dispersed pigments in which the surfaces of pigment particles are chemically functionalized such that a separate dispersant is not necessary; see for example, U.S. Pat. No. 5,630,868; U.S. Pat. No. 6,494,943 B1 and U.S. Pat. No. 5,837,045.

The particle size of pigments used in the ink composition of the invention is not particularly limited, as long as the performance of the ink composition is not compromised. Reliable jetting of the ink composition is a key performance requirement and is often a concern with pigment-based ink compositions, because of the propensity of the pigment particles to clog printhead nozzles. Reliable jetting occurs when the individual streams of ink droplets fire continuously from each of the printhead nozzles without any nozzles shutting down, either temporarily or permanently.

Pigment particle size is typically measured in terms of median particle size. For example, a 50% particle size means that 50% by weight of the particles have a particle size less than that number. Similarly, a 90% particle size means that 90% by weight of the particles have a particle size less than that number, and so on. Preferably, the pigments used in the ink composition of the invention have 50%, more preferably 90% and most preferably 95% particle sizes of less than about 2.0 microns, more preferably less than 1.0 microns, more preferably less than about 200 nm, and even more preferably, less than about 100 nm.

The colorants used in the ink composition of the invention may be present in any effective amount, generally from 0.1 to 10% by weight, and preferably from 0.5 to 6% by weight.

Ink compositions useful in the invention include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. Typical aqueous-based ink compositions useful in the invention may contain, for example, the following components based on the total weight of the ink: water 20-95%, humectant(s) 5-70%, and co-solvent(s) 2-20%.

Other components present in the ink composition of the invention include surfactants, defoamers, biocides, buffering agents, conductivity enhancing agents, anti-kogation agents, drying agents, waterfast agents, chelating agents, inorganic particles, polymeric particles, polymer dispersions, other water soluble polymers, light stabilizers, or ozone stabilizers.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of ink jet printing. Acceptable viscosities are no greater than 20 cP, and preferably in the range of about 1.0 to 6.0 cP. Acceptable surface tensions are no greater than 60 dynes/cm, and preferably in the range of 28 dynes/cm to 45 dynes/cm.

The invention can be used in conjunction with any type of image-recording element, including but not limited to plain paper, vinyl, canvas, and specialty paper designed specifically for use with ink jet printing.

Ink jet inks are employed in ink jet printing wherein liquid ink drops are applied in a controlled fashion to an ink receiving substrate, by ejecting ink droplets from plurality of nozzles, or orifices, in a print head of ink jet printers. Commercially available ink jet printers use several different methods to control the deposition of the ink droplets. Such methods are generally of two types: continuous stream and drop-on-demand.

In drop-on-demand systems, a droplet of ink is ejected from an orifice directly to a position on the ink receiving layer by pressure created by, for example, a piezoelectric device, an acoustic device, or a thermal process controlled in accordance digital data signals. An ink droplet is not generated and ejected through the orifices of the print head unless it is needed. Ink jet printing methods, and related printers, are commercially available and need not be described in detail.

The following examples illustrate, but do not limit, the utility of the present invention.

### EXAMPLES

Preparation of Polymer Dispersions

Preparation of Comparative Polymer (SP-C)

Water soluble polymer Trudot IJ-4655® was obtained from MeadWestvaco. The polymer was then neutralized with KOH to obtain a styrene acrylic polymer solution at 25% Solids. The estimated content of the hydrophilic components in this polymer is about 40% by weight by titration.

Preparation of Solution Polymer 1 of the Invention (SP-1)

100 g of diethylene glycol and 0.25 g of AIBN (azobisisobutylronitril) were charged to a 1-liter, three-neck round-bottom flask equipped with a mechanical stirrer and nitrogen inlet. The solution was purged with nitrogen for 20 min and heated to 150° C. in a constant temperature bath. 100 g of diethylene glycol, 0.25 g of AIBN, 22.5 g of methyl methacrylate, 5.0 g of butyl acrylate, 5.0 g of vinyl acetate, and 17.5 g of methacrylic acid were stirred and mixed well. Then the mixture was funneled into the reactor over 2 hours. Polymerization was continued for 3 hours. The temperature was reduced to 65-70° C. and 1 ml each of t-butyl hydroperoxide (10%) and sodium formaldehyde bisulfite (10%) were post-added. This polymer dispersion is designated as Solution Polymer 1 (SP-1).

Preparation of Solution Polymer 2 of the Invention (SP-2)

100 g of diethylene glycol and 0.25 g of AIBN were charged to a 1-liter, three-neck round-bottom flask equipped with a mechanical stirrer and nitrogen inlet. The solution was purged with nitrogen for 20 min and heated to 150 C in a constant temperature bath. 100 g of diethylene glycol, 0.25 g of AIBN, 22.5 g of methyl methacrylate, 10 g of vinyl acetate, and 17.5 g of methacrylic acid were stirred and mixed well. Then the mixture was funneled into the reactor over 2 hours. Polymerization was continued for 3 hours. The temperature was reduced to 65-70° C. and 1 ml each of t-butyl hydroperoxide (10%) and sodium formaldehyde bisulfite (10%) were post-added. This polymer dispersion is designated as Solution Polymer 2 (SP-2).

Preparation of Solution Polymer 3 of the Invention (SP-3)

100 g of diethylene glycol and 0.25 g of AIBN were charged to a 1-liter, three-neck round-bottom flask equipped with a mechanical stirrer and nitrogen inlet. The solution was purged with nitrogen for 20 min and heated to 150° C. in a constant temperature bath. 100 g of diethylene glycol, 0.25 g of AIBN, 12.5 g of methyl methacrylate, 20 g of vinyl acetate, and 17.5 g of acrylic acid were stirred and mixed well. Then the mixture was funneled into the reactor over 2 hours. Polymerization was continued for 3 hours. The temperature was reduced to 65-70° C. and 1 ml each of t-butyl hydroperoxide (10%) and sodium formaldehyde bisulfite (10%) were post-added. This polymer dispersion is designated as Solution Polymer 3 (SP-3).

Preparation of Solution Polymer 4 of the Invention (SP-4)

100 g of (2-butanone) MEK and 0.25 g of AIBN were charged to a 1-liter, three-neck round-bottom flask equipped with a mechanical stirrer and nitrogen inlet. The solution was purged with nitrogen for 20 min and heated to 60° C. in a constant temperature bath. 100 g of MEK, 0.25 g of AIBN, 12.5 g of methyl methacrylate, 20 g of vinyl acetate, and 17.5 g of acrylic acid were stirred and mixed well. Then the mixture was funneled into the reactor over 2 hours. Polymerization was continued for 3 hours. The temperature was reduced to 25° C. and 1 ml each of t-butyl hydroperoxide (10%) and sodium formaldehyde bisulfite (10%) were post-added. After cooling, the resulting solution was added slowly to rapidly stirred enough amount of hexane solvent. White precipitation then appeared. The whole mixture was filtered under suction and dried in vacuo to give a white powder. The powder polymer was then dissolved into basic water (KOH as neutralizing agent) with PH around 7 and solids around 25%. This polymer dispersion is designated as Solution Polymer 4 (SP-4).

Polymer Characterization

Number Average Molecular Weight:

The samples were analyzed by size-exclusion chromatography (SEC) in tetrahydrofuran using three Polymer Laboratories Plgel® mini-mixed-B columns. The column set was calibrated with narrow molecular weight distribution polystyrene standards between 580 and 2,300,000. The average number molecular weight of the polymers measured to be: SP-1, 10,600; SP-2, 11,000; SP-3, 9,800; and SP-4, 9,300.

Glass Transition Temperature (Tg):

The glass transition temperature of the polymers were estimated by the homopolymer's theoretical values. The Tg of the polymers are: SP-1, 60° C.; SP-2, 55° C.; SP-3, 35° C.; SP-4, 35° C.

Polymer Water Solubility

Polymer solubility was measured as follows: polymer was added gradually into 100 g of water at a constant temperature, e.g. 25 degree C. When a certain amount of polymer was added, the solution would change from transparent to cloudy. The amount of polymer added before this transition was observed is defined as the water solubility of this polymer. Here in this invention, the water soluble polymer was defined as a polymer having a water solubility of 0.5 weight % or higher at 25 degree C.

Preparation of Pigment Dispersion

Magenta Pigment Dispersion (PD-M)

The magenta pigment dispersion contains: 300 g of Polymeric beads, mean diameter of 50 μm (milling media); 30 g of quinacridone magenta pigment Pigment Red 122 (Sun Chemicals); 9 g of Oleoyl methyl taurine, (OMT) Potassium salt, 208 g of Deionized water, and 0.2 g of Proxel GXL® (biocide from Zeneca). The above components were milled in a 2 liter double walled vessel obtained from BYK-Gardner using a high energy media mill manufactured by Morehouse-Cowles Hochmeyer. The mill was run for approximately 8 hours at room temperature. The dispersion was separated from the milling media by filtering the millgrind through a 4-8 μm KIMAX® Buchner Funnel obtained from VWR Scientific Products. At the end of milling, additional water was added to the dispersion so that the pigment was about 10.0% by weight of the total final dispersion and the biocide was about 230 ppm by weight of the total final dispersion. The amount of OMT Potassium salt contained in the final dispersion was 30 weight % based on the pigment. The 50% and 95% particle sizes were about 15 nm and 60 nm as measured by MICROTRAC II Ultrafine particle analyzer (UPA) manufactured by Leeds & Northrup.

Yellow Pigment Dispersion 1 (PD-Y1)

This dispersion was prepared the same as the Magenta Pigment Dispersion (PD-M) except that Pigment Yellow 155 (Clariant Corp.) was used instead of the quinacridone magenta pigment Pigment Red 122. The amount of OMT Potassium salt contained in the final dispersion was 25 weight % based on the pigment. The 50% and 95% particle sizes were about 13 nm and 69 nm as measured by MICROTRAC II Ultrafine particle analyzer (UPA) manufactured by Leeds & Northrup.

Yellow Pigment Dispersion 2 (PD-Y2)

This dispersion was prepared the same as the Yellow Pigment Dispersion 1 (PD-Y1) except that Pigment Yellow 97 (Novaperm Yellow FGL® from the Clariant Corp.) was used instead of Pigment Yellow 155. The amount of OMT Potassium salt contained in the final dispersion was 25 weight % based on the pigment. The 50% and 95% particle sizes were about 14 nm and 60 nm as measured by MICROTRAC II Ultrafine particle analyzer (UPA) manufactured by Leeds & Northrup.

Yellow Pigment Dispersion 3 (PD-Y3)

This dispersion PD-Y3 was prepared by combining 30 g of Pigment Yellow 97 (Novaperm Yellow FGL® from the Clariant Corp.), 56 g of a 27 wt % aqueous solution of polymer SP-4, 114 g of high purity water, and 220 g of 50-micron polymeric media in a 1 L water-jacketed vessel. The mixture was stirred with a 50 mm diameter cowles blade at a speed of 1830 rev/min for 20 hours as the temperature of the water in the vessel jacket was held at 23° C. After the milling time period, the pigment dispersion was separated from the polymeric beads by filtering through a 5-micron filter. The final dispersion was adjusted to 10 wt % pigment with high purity water. The 50% and 90% particle sizes of the final dispersion were about 22 nm and 104 nm as measured by MICROTRAC II Ultrafine particle analyzer (UPA) manufactured by Leeds & Northrup.

Cyan Pigment Dispersion (PD-C)

This dispersion was prepared the same as the Magenta Pigment Dispersion (PD-M) except that Copper phthalocyanine PB15:3 (Sun Chemicals.) was used instead of the quinacridone magenta pigment Pigment Red pigment. The amount of OMT Potassium salt contained in the final dispersion was 25 weight % based on the pigment. The 50% and 90% particle sizes were about 31 nm and 76 nm as measured by MICROTRAC II Ultrafine particle analyzer (UPA) manufactured by Leeds & Northrup.

Black Pigment Dispersion (PD-K)

This dispersion was prepared the same as the Magenta Pigment Dispersion (PD-M) except that Black Pearl 880 (Cabot Corp.) was used instead of the quinacridone magenta pigment Pigment Red pigment. The amount of OMT Potassium salt contained in the final dispersion was 25 weight % based on the pigment. The 50% and 90% particle sizes were about 68 nm and 160 nm as measured by MICROTRAC II Ultrafine particle analyzer (UPA) manufactured by Leeds & Northrup.

Ink Formulation

Cyan Ink 1 of the Invention (I-C1)

To prepare the Cyan Ink I-C1, 17.5 g of Pigment Dispersion PD-C (10% pigment by weight), 16.7 g Strodex PK-90 solution of 3 weight % active (Dexter Chemical), 16.0 g diethylene glycol, 0.7 g of Triethanolamine (20% active by weight) and 8.0 g of solution polymer SP-1 (11% active by weight) were added together with distilled water so that the final weight of the ink was 100.0 g. The final ink contained 1.75% Copper phthalocyanine PB15:3 pigment, 0.50% Strodex PK-90, 16% diethylene glycol. The solution was filtered through a 3 μm polytetrafluoroethylene filter.

Cyan Ink 2 of the Invention (I-C2)

Cyan Ink 2 was prepared the same as the Cyan Ink 1 except that solution polymer SP-2 (11% active by weight) was used instead of solution polymer SP-1. The 50% and 95% particle size of the ink are about 51 nm and 102 nm as measured by MICROTRAC II Ultrafine particle analyzer (UPA) manufactured by Leeds & Northrup.

Cyan Ink 3 of the Invention (I-C3)

Cyan Ink 3 was prepared the same as the Cyan Ink 1 except that solution polymer SP-3 (11% active by weight) was used instead of solution polymer SP-1. The 50% and 95% particle size of the ink are about 67 nm and 105 nm as measured by MICROTRAC II Ultrafine particle analyzer (UPA) manufactured by Leeds & Northrup.

Comparative Cyan Ink (C-C)

Comparative Cyan Ink was prepared the same as the Cyan Ink 1 except that Comparative Polymer SP-C (25% active by weight) was used instead of solution polymer SP-1. The 50% and 95% particle size of the ink are about 53 nm and 91 nm as measured by MICROTRAC II Ultrafine particle analyzer (UPA) manufactured by Leeds & Northrup.

Magenta Ink 1 of the Invention (I-M1)

To prepare the Magenta Ink I-M1, 29.3 g of Pigment Dispersion PD-M (9.92% pigment by weight), 25 g Strodex PK-90 solution of 3 weight % active (Dexter Chemical), 12.0 g diethylene glycol, 0.35 g of Triethanolamine (20% active by weight) and 13.2 g of solution polymer SP-1 (11% active by weight) were added together with distilled water so that the final weight of the ink was 100.0 g. The final ink contained 2.9% Pigment Red 122, 0.75% Strodex PK-90, 12% diethylene glycol. The solution was filtered through a 3 μm polytetrafluoroethylene filter. The 50% and 95% particle sizes of the ink were about 22 nm and 82 nm as measured by MICROTRAC II Ultrafine particle analyzer (UPA) manufactured by Leeds & Northrup.

Magenta Ink 2 of the Invention (I-M2)

Magenta Ink 2 was prepared the same as the Magenta Ink 1 except that solution polymer SP-2 (11% active by weight) was used instead of solution polymer SP-1.

Magenta Ink 3 of the Invention (I-M3)

Magenta Ink 3 was prepared the same as the Magenta Ink 1 except that solution polymer SP-3 (11% active by weight) was used instead of solution polymer SP-1. The 50% and 95% particle sizes of the ink were about 16 nm and 67 nm as measured by MICROTRAC II Ultrafine particle analyzer (UPA) manufactured by Leeds & Northrup.

Comparative Magenta Ink (C-M)

Comparative Magenta Ink C-M was prepared the same as the Magenta Ink 1 except that Comparative Polymer SP-C (25% active by weight) was used instead of solution polymer SP-1. The 50% and 95% particle sizes of the ink were about 25 nm and 63 nm as measured by MICROTRAC II Ultrafine particle analyzer (UPA) manufactured by Leeds & Northrup.

Yellow Ink 1 of the Invention (I-Y1)

To prepare the Yellow Ink I-Y1, 25 g of Pigment Dispersion PD-Y1 (10.0% pigment by weight), 21.7 g Strodex PK-90 solution of 3 weight % active (Dexter Chemical), 16.0 g diethylene glycol, 0.2 g of Triethanolamine (20% active by weight) and 11.4 g of solution polymer SP-1 (11% active by weight) were added together with distilled water so that the final weight of the ink was 100.0 g. The final ink contained 2.5% Pigment yellow 155, 0.65% Strodex PK-90, 16% diethylene glycol. The solution was filtered through a 3 μm polytetrafluoroethylene filter. The 50% and 95% particle sizes of the ink were about 12 nm and 32 nm as measured by MICROTRAC II Ultrafine particle analyzer (UPA) manufactured by Leeds & Northrup.

Yellow Ink 2 of the Invention (I-Y2)

Yellow Ink 2 was prepared the same as the Yellow Ink 1 except that solution polymer SP-2 (11% active by weight) was used instead of solution polymer SP-1. The 50% and 95% particle sizes of the ink were about 12 nm and 36 nm as measured by MICROTRAC II Ultrafine particle analyzer (UPA) manufactured by Leeds & Northrup.

Yellow Ink 3 of the Invention (I-Y3)

Yellow Ink 3 was prepared the same as the Yellow Ink 1 except that solution polymer SP-3 (11% active by weight) was used instead of solution polymer SP-1. The 50% and 95% particle sizes of the ink were about 12 nm and 38 nm as measured by MICROTRAC II Ultrafine particle analyzer (UPA) manufactured by Leeds & Northrup.

Yellow Ink 4 of the Invention (I-Y4)

To prepare the Yellow Ink I-Y4, 25 g of Pigment Dispersion PD-Y3 (10.0% pigment by weight), 21.7 g Strodex PK-90 solution of 3 weight % active (Dexter Chemical), 16.0 g diethylene glycol, 0.2 g of Triethanolamine (20% active by weight were added together with distilled water so that the final weight of the ink was 100.0 g. The final ink contained 2.5% Pigment yellow 97, 0.65% Strodex PK-90, 16% diethylene glycol. The solution was filtered through a 3 μm polytetrafluoroethylene filter.

Comparative Yellow Ink (C-Y1)

Comparative Yellow Ink was prepared the same as the Yellow Ink 1 except that Comparative Polymer SP-C (25% active by weight) was used instead of solution polymer SP-1. The 50% and 95% particle sizes of the ink were about 13 nm and 54 nm as measured by MICROTRAC II Ultrafine particle analyzer (UPA) manufactured by Leeds & Northrup.

Comparative Yellow Ink (C-Y2)

Comparative Yellow Ink 2 (C-Y2) was prepared the same as the Comparative Yellow Ink 1 (C-Y1) except that yellow pigment dispersion PD-Y2 (10% active by weight) was used instead of yellow pigment dispersion PD-Y1. The 50% and 95% particle sizes of the ink were about 15 nm and 81 nm as measured by MICROTRAC II Ultrafine particle analyzer (UPA) manufactured by Leeds & Northrup.

Black Ink 1 of the Invention (I-K1)

To prepare the Black Ink I-K1, 21.5 g of Pigment Dispersion PD-K (10.0% pigment by weight), 3.3 g Strodex PK-90 solution of 3 weight % active (Dexter Chemical), 12.0 g diethylene glycol, 0.3 g of Triethanolamine (20% active by weight) and 9.8 g of solution polymer SP-1 (11% active by weight) were added together with distilled water so that the final weight of the ink was 100.0 g. The final ink contained 2.15% Carbon Black, 0.1% Strodex PK-90, 12% diethylene glycol. The solution was filtered through a 3 μm polytetrafluoroethylene filter.

Black Ink 2 of the Invention (I-K2)

Black Ink 2 was prepared the same as the Black Ink 1 except that solution polymer SP-2 (11% active by weight) was used instead of solution polymer SP-1. The 50% and 95% particle sizes of the ink were about 72 nm and 111 nm as measured by MICROTRAC II Ultrafine particle analyzer (UPA) manufactured by Leeds & Northrup.

Black Ink 3 of the Invention (I-K3)

Black Ink 3 was prepared the same as the Black Ink 1 except that solution polymer SP-3 (11% active by weight) was used instead of solution polymer SP-1. The 50% and 95% particle sizes of the ink were about 60 nm and 128 nm as measured by MICROTRAC II Ultrafine particle analyzer (UPA) manufactured by Leeds & Northrup.

Comparative Black Ink (C-K)

Comparative Black Ink was prepared the same as the Black Ink 1 except that Comparative Polymer SP-C (25% active by weight) was used instead of solution polymer SP-1. The 50% and 95% particle sizes of the ink were about 68 nm and 110 nm as measured by MICROTRAC II Ultrafine particle analyzer (UPA) manufactured by Leeds & Northrup.

Ink Firability Test

The inks of the present invention were filled into empty cartridges designed for an Encad Novajet 850 wide format printer. They were printed as a CMYK ink set through the Encad Novajet 850 CMYK ink channels. All inks of the invention fired well through this printer with no nozzle clogging. The inks were left in the printer for over 48 hours and the above printing test was repeated. All the nozzles fired with minimum manual interventions after the 48 hours rest run period.

Ozone Stability Test

Using Encad Novajet 850 printer, test images were printed. They consist of a series of 6 variable density patches, approximately 15 by 13 mm in size, ranging from 5% dot coverage to 100% dot coverage printed onto two commercially available receivers: Hewlett Packard Durable Image Gloss UV (R-1), Go water resistant self-adhesive vinyl (R-2). The elements were allowed to dry for 24 hours at ambient temperature and humidity.

The above test images were then placed in an ozone chamber (˜5 ppm ozone level, 50% relative humidity) for 5 days. The Status A reflection densities of patches of the elements were measured using an spectrolino densitometer before and after the ozone fade test. % Fade is calculated based on the Status A Density loss from of the interpolated initial density of 1.0. They are listed in Table 1.

TABLE 1
Ozone Test Results

| | |
|---|---|
| Element Containing | Ozone Test (% Fade) |

| Example Ink | Receiver: R-1 | Receiver: R-2 |
|---|---|---|
| Inventive ink I-C1 | 8.8 | 6.1 |
| Control ink C-C | 11.6 | 8.0 |
| Inventive ink I-M1 | 5.2 | 5.5 |
| Control ink C-M | 13.1 | 7.9 |
| Inventive ink I-Y1 | 3.0 | 3.0 |
| Control ink C-Y1 | 3.6 | 3.9 |
| Inventive ink I-Y4 | 7.0 | 0 |
| Control ink C-Y2 | 11.0 | 6.0 |

The above results show that the elements of the invention had improved ozone stability as compared to the control elements.

Weatherability Test

Using Encad Novajet 850 printer, test images were printed. They consist of a series of 6 variable density patches, approximately 15 by 13 mm in size, ranging from 5% dot coverage to 100% dot coverage printed onto commercially available receiver Go water resistant self-adhesive vinyl. The elements were allowed to dry for 24 hours at ambient temperature and humidity.

The above test images were then placed in a Q-SUN weatherometer (Q-SUN/3000 Xenon Test Chamber from Q-Panel Lab Products) for 7 and 14 days. The test chamber was set to maintain a black panel temperature of 63° C. The light condition was set to be 65 klux sunlight 24 hours. In addition, a cycle of 20 minutes water spray for every 2 hours was applied to simulate the rain falls in the outdoor environment. Status A reflection densities of patches of the elements were measured using an spectrolino densitometer before and after the ozone fade test. % Fade is calculated based on the Status A Density loss from of the interpolated initial density of 1.0. They are listed in Table 2.

TABLE 2
Weatherability Test Results

| | |
|---|---|
| Element Containing | Weatherability Test (% Fade) |

| Example Ink | 7 days | 14 days |
|---|---|---|
| Inventive ink I-C1 | 7.4 | 24.3 |
| Control ink C-C | 11.8 | 35.2 |
| Inventive ink I-M1 | 9.0 | 20.3 |
| Control ink C-M | 12.3 | 29.8 |
| Inventive ink I-Y1 | 5.7 | 18 |
| Control ink C-Y1 | 8.8 | 22.6 |

The above results show that the elements of the invention had improved weatherability stability as compared to the control elements.

Image Quality Evaluation (Inter-Color Bleed Test)

Using Encad Novajet 850 printer, test images were printed unto Kodak water resistant self-adhesive vinyl. The images consist of a series of 0.55 cm by 0.55 cm solid D max squares adjacent to different colors. This pattern is designed to evaluate the inter-color bleed between a wide range of primary (cyan, magenta, yellow and black) and secondary colors (red, green and blue). Since both the print speed as well as ink laydown/coverage have significant impact on the severity of the inter-color bleed, all the tests were carried out using the Onyx Production House software (Onyx Graphics) with Encad Novajet 850 printer driver. No ink limits were employed for all the four channels. The printer was set to print at 4 passes, Speed 10 and with Bi-directional printing.

The extent of inter-color bleed was measured as the width of the colors invading to the adjacent patches for selected sensitive color combinations, such as Green to Yellow Bleed and Blue to Yellow Bleed. The results are listed in Table 3.

TABLE 3
Inter-Color Bleed Test Results

| Element | | | | | Inter-Color Bleed (mm) | |
|---|---|---|---|---|---|---|
| Containing | Inks | | | | Green to | Green to |
| Example Ink set | C | M | Y | K | Yellow | Yellow |
| Comparative-1 | C-C | C-M | C-Y1 | C-K | 0.75 | 0.75 |
| Invention 1 | I-C1 | I-M1 | I-Y1 | I-K1 | None | 0.1 |
| Invention 2 | I-C2 | I-M2 | I-Y2 | I-K2 | 0.3 | 0.3 |
| Invention 3 | I-C3 | I-M3 | I-Y3 | I-K3 | None | 0.1 |

The above results show that the elements of the invention had improved inter-color bleed as compared to the control elements.

The invention has been described in detail with particular reference to certain preferred embodiments thereof, but it will be understood that variations and modifications can be effected within the spirit and scope of the invention.

1. An ink jet ink composition comprising water, a humectant, a non-encapsulated pigment and a water soluble polymer, wherein the polymer comprises a vinyl acetate monomer and has a number average molecular weight less than 200,000.

2. The ink jet ink composition of claim 1 wherein the polymer has a number average molecular weight less than 150,000.

3. The ink jet ink composition of claim 1 wherein the polymer has a number average molecular weight less than 100,000.

4. The ink jet ink composition of claim 1 wherein the polymer has a number average molecular weight less than 50,000.

5. The ink jet ink composition of claim 1 wherein the polymer has a number average molecular weight less than 20,000.

6. The ink jet ink composition of claim 1 wherein the polymer has a water solubility of 0.5 weight % at 25 degrees C. or more.

7. The composition of claim 1 wherein said the polymer is used as a dispersant.

8. The composition of claim 1 wherein said the polymer is used as an additive and the composition further comprises a dispersant.

9. The composition of claim 1 wherein said the vinyl acetate monomer is 1 to 90 weight % of the polymer.

10. The composition of claim 1 wherein said the vinyl acetate monomer is 5 to 50 weight % of the polymer.

11. The composition of claim 1 wherein said polymer further comprises a hydrophilic monomer which is an acrylic acid, methacrylic acid, acrylimide, ethacrylic acid, acrylamide, methacrylamide, N,N-dimethyl acrylamide, N-methyl acrylamide, N-methyl methacrylamide, aryloxy dimethyl acrylamide, N-methyl acrylamide, N-methyl methacrylamide, aryloxy piperidine, and N,N-dimethyl acrylamide chloromethacrylic acid, maleic acid, allylamine, N,N-diethylallylamine, vinyl sulfonamide, sodium acrylate, sodium methacrylate, ammonium acrylate, ammonium methacrylate, acrylamidopropanetriethylammonium chloride, methacrylamidopropane-triethylammonium chloride, vinyl-pyridine hydrochloride, sodium vinyl phosphonate and sodium 1-methylvinylphosphonate, sodium vinyl sulfonate, sodium 1-methylvinyl-sulfonate, sodium styrenesulfonate, sodium acrylamidopropanesulfonate, sodium methacrylamidopropanesulfonate, or sodium vinyl morpholine sulfonate monomer or combinations thereof.

12. The composition of claim 1 wherein said polymer further comprises a hydrophilic monomer comprising carboxylic acid.

13. The composition of claim 1 wherein said polymer further comprises an additional hydrophobic monomer.

14. The composition of claim 13 wherein the additional hydrophobic monomer is an allyl compound, a vinyl ether, a vinyl heterocyclic compound, styrene, an olefin or halogenated olefin, an ethylenically unsaturated carboxylic acid or esters derived from them, an unsaturated nitrile, vinyl alcohol, acrylamide or methacrylamide, vinyl ketone, or a multifunctional monomer, and copolymers formed therefrom.

15. The composition of claim 13 wherein the additional hydrophobic monomer is acrylate or methacrylate and their derivatives.

16. The composition of claim 1 wherein the polymer has a Tg of −50 to 150 degrees C.

17. The composition of claim 1 wherein the polymer has a Tg of 5 to 100 degrees C.

18. The composition of claim 1 wherein said polymer comprises from about 0.5% to about 5% by weight of said ink.

19. The composition of claim 1 wherein said pigment is C.I. Pigment Blue 15:3, C.I. Pigment Red 122, C.I. Pigment Yellow 155, Pigment Yellow 97, C.I. Pigment Yellow 74, bis(phthalocyanylalumino)tetraphenyldisiloxane or C.I. Pigment Black 7.

20. The composition of claim 1 wherein 90 weight % of the pigment particles have a particle size of less than 1.0 microns.

21. The composition of claim 1 wherein 90 weight % of the pigment particles have a particle size of less than 200 nm.

22. The composition of claim 1 wherein 90 weight % of the pigment particles have a particle size of less than 100 nm.

23. An ink jet printing method comprising the steps of:
A) providing an ink jet printer that is responsive to digital data signals;
B) loading said printer with an ink jet recording element
C) loading said printer with an ink jet ink composition comprising water, a humectant, a non-encapsulated pigment and a water soluble polymer, wherein the polymer comprises vinyl acetate and has a number average molecular weight less than 200,000; and
D) printing on said ink jet recording element using said ink jet ink composition in response to said digital data signals.
